(19) United States
(12) Patent Application Publication
(10) Pub. No.: US 2025/0133400 A1
(43) Pub. Date: Apr. 24, 2025

(54) METHOD AND SYSTEM FOR MANAGING THE USERS OF AN AUTOMATION ENGINEERING FIELD DEVICE

(71) Applicant: Endress+Hauser Conducta GmbH+Co. KG, Gerlingen (DE)

(72) Inventors: Thomas Alber, Stuttgart (DE); Simon Merklin, Bahlingen a.K. (DE)

(21) Appl. No.: 18/918,244

(22) Filed: Oct. 17, 2024

(30) Foreign Application Priority Data
Oct. 18, 2023 (DE) 10 2023 128 606.4

(51) Int. Cl. H04W 12/06; H04L 5/00; H04L 9/40; H04W 76/15

(52) U.S. Cl. CPC H04W 12/06; H04L 5/0048; H04L 63/104; H04W 76/15

(57) ABSTRACT

Managing field device users includes establishing a first communications link between a transport medium and user database and sending a ticket from the database to the transport medium via the first communications link. The ticket includes first user data, field device identification information, and second user data. The first user data cannot be processed by the field device and the second user data can be processed by the field device. The user is authenticated to the transport medium based upon the first user data. A field device specific operating telegram is created using the transport medium if the user has been authenticated, wherein the operating telegram contains the second user data. The operating telegram is sent to the field device via a second communications link, verifying the second user data, and granting access from the transport medium to the field device based upon valid second user data.

### CROSS-REFERENCE TO RELATED APPLICATION

The present application is related to and claims the priority benefit of German Patent Application No. 10 2023 128 606.4, filed on Oct. 18, 2023, the entire contents of which are incorporated herein by reference.

### TECHNICAL FIELD

The present disclosure relates to a method for managing the users of an automation engineering field device. The present disclosure further relates to a system designed to carry out the method according to the present disclosure.

### BACKGROUND

Field devices that are used in industrial installations are already known from the prior art. Field devices are often used in process automation engineering, as well as in manufacturing automation engineering. In principle, all devices which are process-oriented and which supply or process process-relevant information are referred to as field devices. Field devices are thus used for detecting and/or influencing process variables. Measuring devices, or sensors, are used for detecting process variables. These are used, for example, for pressure and temperature measurement, conductivity measurement, flow measurement, pH measurement, fill-level measurement, etc., and detect the corresponding process variables of pressure, temperature, conductivity, pH value, fill level, flow, etc. Actuators are used for influencing process variables. These are, for example, pumps or valves that can influence the flow of a fluid in a pipe or the fill level in a tank. In addition to the aforementioned measuring devices and actuators, field devices are also understood to include remote I/O's, radio adapters, or, generally, devices that are arranged at the field level.

A multitude of such field devices are produced and marketed by the Endress+Hauser group.

In modern industrial plants, field devices are usually connected to superordinate units via communications networks such as fieldbuses (Profibus®, Foundation® Fieldbus, HART®, etc.). Usually, the superordinate units are control systems (DCS) or control units, such as an SPC (stored program control). The superordinate units are used for, among other things, process control, process visualization, and process monitoring, as well as commissioning of the field devices. The measured values recorded by the field devices, such as by sensors, are transmitted via the respective bus system to a (or in some cases a plurality of) superordinate unit(s). In addition, data transmission from the superordinate unit via the bus system to the field devices is also required, such as for configuration and parameterization of field devices and for controlling actuators.

Mobile control units can also be used to operate field devices that have implemented an FDT frame application. For example, there are control units that are connected to the fieldbus network. However, the control unit can also communicate with the field devices via a wireless communications connection, in particular based upon a Bluetooth standard. The applicant produces and sells devices which, as so-called Bluetooth gateways, allow the control units to be coupled to the field devices. The field device is connected to a Bluetooth gateway in a wired manner, in particular using the HART or CDI communications standards. Alternatively, the field devices themselves have their own Bluetooth interfaces.

When using a mobile device, such as a smartphone or tablet, as a control unit for wireless communication with the field devices, application programs—so-called apps—are available which provide the mobile device with the operating functions for the field device.

In industrial environments, most of the installed field devices have no or only very basic protection against unauthorized access. In these field devices, all device parameters can usually be accessed directly or, for example, after entering an unlock code. As part of the Federal Security Act, more and more field devices are entering the market that have individual user accounts and role-based authorization. For access via a user interface or machine interface, an, in a certain sense “permanent,” authorization is required, which is usually granted by prior authentication. The authorization must be chosen in such a way that the access user has (permanently) all the authorizations they need to carry out their tasks. Standards such as IEC 62443-4-2 describe how to implement a state-of-the-art authentication mechanism.

Due to the resulting immense administrative effort for the login data of the field devices, technologies for central user administration are emerging, as has been common practice in the IT sector for years with regard to IT devices (for example, printers, workstations, etc.). An example of such a concept is disclosed in DE 10 2018 1026 08 A1, in which a transport medium is provided to which user data are transferred from a user database, wherein access to the field device is granted after checking the user data therefor.

There are also ideas for limiting the access permissions required by people to a minimum. DE 102019131860 A1, for example, discloses providing a digital order ticket which is transmitted from a server to the mobile device, which order ticket contains the access rights and the authorized tasks for the field device. This order ticket is transmitted when the connection is established with the field device. If authorization is available, the tasks contained in the order ticket, such as parameterization actions or execution of functional tests, can be processed with the field device.

The problem is that such concepts often cannot be implemented in the base installed in field devices (the so-called “brownfield”). This is because, in addition to software implemented outside the devices, a special communications interface provided in the field device is also required. This means that an installation operator can centrally administer only new field devices, while the old devices still require manual administration. This means that different safety levels continue to exist between the different field device generations.

### SUMMARY

Proceeding from this problem, the object of the present disclosure is to present a concept which allows for central user management also for existing field devices.

A method according to the present disclosure serves for user management of an automation engineering field device and comprises the following method steps establishing a first communications link between a transport medium and a user database, in particular via a local network or via the Internet; sending a ticket created by the user database from the user database to the transport medium via the first communications link, wherein the ticket at least comprises cryptographically secured information, first user data, and identification information of the field device, wherein the ticket comprises second user data, wherein the first user data are in a format that cannot be processed by the field device, and wherein the second user data are in a format that can be processed by the field device; authenticating the user to the transport medium based upon the first user data; creating of a field device-specific operating telegram using the transport medium in the event that the user has been successfully authenticated to the transport medium, wherein the operating telegram contains the second user data; sending the operating telegram from the transport medium to the field device via a second communications link; verifying the second user data by means of the field device; and granting access from the transport medium to the field device based upon verified valid second user data.

The method also makes it possible to implement the method of central user management known from DE 102019131860 A1 for existing field devices (so-called “brownfield” field devices) without changing the software or hardware of the field devices for this purpose. The core of the method consists in that the transport medium carries out a “mapping” procedure, i.e., a transformation between the ticket created and transmitted by the user database, and the operating telegram transmitted to the field device. The ticket contains first user data, which enable the user to log in to, or be authenticated to, the transport medium. Different users and their authorizations for individual field devices are stored in the user database. In addition, the ticket already contains second user data, which are integrated into the operating telegram and which enable the transport medium to be registered with the field device. The operating telegram is created specifically for the field device, based upon identification information of the field device, which is also included in the ticket.

Generally speaking, a ticket may be a data packet that contains cryptographically secured information. The recipient of the ticket is therefore able to verify the authenticity and integrity of a ticket.

An operating telegram is a data packet that is addressed to a field device and contains the second user data and optionally at least one operating command for the field device. The operating telegram is created in a specific data format that can be understood by the field device. The specific data format depends upon the communications protocol by means of which the field device can be operated.

Examples of field devices that are mentioned in connection with the present disclosure have already been listed in the introductory part of the description.

According to an advantageous embodiment of the method, the first user data contain a user name and a password. After the ticket is received by the transport medium, the user is asked to enter these first user data. The method is continued only after the first user data entered by the user and the user data contained in the ticket have been compared and match. Alternatively, the first user data may also contain a request for the user to authenticate themselves to the transport medium in an alternative way, e.g., by means of biometric features such as a fingerprint or the like.

According to an advantageous embodiment of the method, the second user data contain a password or a PIN. These second user data correspond to a format that can be understood and accepted by the field device. At least one password or PIN is stored on each field device, which is also saved in the user database. The user does not learn any information about the second user data when carrying out the method, and therefore only the central administrator managing the user database comes into contact with the second user data. In the there is at least one password, i.e., COABA is also an instrument for the automated management of the local administration data (Maintenance PW, Expert Code). Only the central admin comes into contact with the device PW.

One embodiment of the method provides that the second communications link be established before or after the step of creating the field device-specific operating telegram.

According to an advantageous development of the method according to the present disclosure, the field device contains a plurality of operable functionalities, wherein the availability of operable functionalities is grouped into different authorization groups. Examples of operating functionalities include, inter alia, reading out and/or changing parameters of the field device, performing (self-) diagnostic tests of the field device, reading out measured values, etc. An authorization group includes at least one permitted functionality. Examples of authorization groups include maintenance personnel (permitted functionalities include reading parameters, running diagnostic tests, etc.) and commissioning service personnel (permitted functionalities correspond to those of maintenance personnel plus write access to the parameters).

In particular, it is provided that the second user data be designed in such a way that they allow a login to the field device according to the user's authorization group, which allows a login to the field device according to the user's authorization group. For example, separate second user data are available for each authorization group. Alternatively, separate second user data can also be available for each user.

One embodiment of the method provides that the field device be registered in advance in the user database, wherein the registration process comprises the addition of first user data and second user data. For example, various users are created in the user database and assigned to the field device, wherein each of the users is assigned second user data of the field device via the user roll.

In this case, it is advantageously provided that the second user data for the field device be changed in the user database, a ticket be created by the user database which contains an operating command for the field device to change the second user data in the field device. Such a modification to the second user data can, for example, be made only by a special authorization group, and therefore the entry of special second user data, e.g., a special “change password,” is provided for changing the second user data. After receiving the operating command, an advantageous embodiment of the method provides that the field device transmit the second user data and a confirmation to the transport medium, wherein the transport medium transmits a ticket to the user database containing the confirmation. The data in the user database are then updated.

An advantageous development of the method provides that the tickets exchanged between the user database and the transport medium be encrypted or signed. In particular, each piece of cryptographic relevant information is transmitted from the user database to the transport medium and from the transport medium to the user database, wherein said ticket is encrypted or signed on the basis of the cryptographically relevant information exchanged. The cryptographically relevant information consists, for example, of public keys of a key pair (wherein the key pair consists of a private key, which remains on the user database or on the transport medium, and the public key). Alternatively, this information is information that is required for so-called “challenges,” by means of which the transport medium and the user database establish a trust relationship.

By signing the ticket, the transport medium can verify the authenticity and integrity of the ticket described above. Together with the authentication of the user to the transport medium, high security of the method is achieved.

With regard to the system according to the present disclosure, said method is designed to carry out the method according to the present disclosure and comprises an automation engineering field device, a transport medium, and a user database.

An advantageous embodiment of the system provides that the transport medium be a computer unit or a mobile device, in particular a smartphone or tablet. The transport medium has special software or a special application that can read and understand the ticket, authenticate the user, and create and transmit the operating telegram.

According to an advantageous embodiment of the system, the second communications link between the transport medium and the field device is established via a wired, in particular proprietary, connection. One example of a proprietary connection is the CDI (“Common Data Interface”) protocol used in the field devices by the applicant. Alternatively, the wired connection can be an automation engineering fieldbus—for example, according to one of the common protocols, such as HART, Foundation Fieldbus, Profibus PA/DP, etc.

An advantageous embodiment of the system provides that the user database be a cloud-based database. In this case, the connection between the transport medium and the user database is made via the Internet.

Alternatively, the user database can be located close to the system and, for example, integrated into the installation's control center. In this case, the connection between the transport medium is made via a local network—for example, wired as an Ethernet connection or wired via WLAN.

### BRIEF DESCRIPTION OF THE DRAWINGS

The present disclosure is explained in greater detail with reference to the following FIGURE:

FIG. 1 shows a schematic overview of an exemplary embodiment of the method according to the present disclosure, which is compared with the prior art.

### DETAILED DESCRIPTION

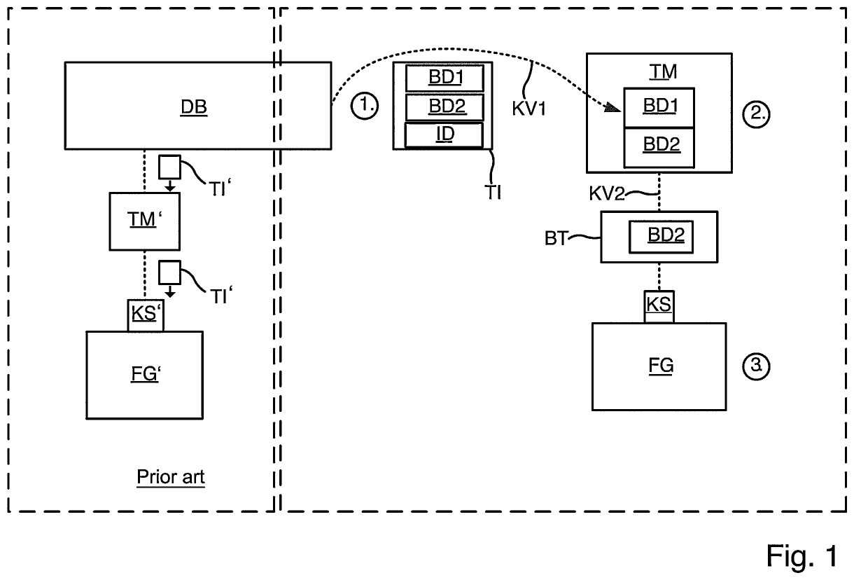

In FIG. 1, the left-hand box shows a solution for managing the users of automation engineering field devices, as is known from the prior art. The right-hand box shows an exemplary embodiment of the method according to the present disclosure.

Various user accounts, authorization groups, and field devices are stored in a central user database DB. The user accounts contain first user data, e.g., in the form of login information such as username and password. The three data records are linked in such a way that the user accounts are assigned authorization groups for the individual field devices. To operate a field device FG′, the user database DB creates a ticket TI′ after a user has successfully logged in to the user database using the first user data. The ticket TI′ contains a cryptographically signed data field, which contains an operating command for the field device FG′, provided that the user's user account is in the corresponding authorization group for the field device FG′. The ticket is transmitted via the local network or via the Internet to a transport medium TM′, which transport medium TM′ is, for example, a laptop or a mobile device, in particular a smartphone or a tablet. Alternatively, the transport medium can also be a passive storage medium such as a USB stick or an SD card.

The transport medium TM′ connects to a communications interface KS' of the field device FG′ and transmits the ticket TI′ to the field device FG′. For example, the transport medium TM′ connects via Bluetooth to the Bluetooth-enabled communications interface KS' of the field device FG. If the transport medium TM′ is a passive storage medium, the connection process comprises inserting the storage medium into the communications interface, which is designed, for example, as a card slot.

Since the user database DB and the field device FG′ have exchanged cryptographically relevant information in advance, e.g., in the form of a public key of a key pair, the field device FG′ can check the authenticity and integrity of the ticket TI′. If the check proves the authenticity and integrity of the ticket, the field device FG′ processes the contents of the ticket TI′ and, for example, executes an operating command contained in the ticket TI′.

These steps make it clear that the method known from the prior art requires a modern field device FG′, which must have a corresponding communications interface KS' for connecting the transport medium TM′, as well as correspondingly suitable resources (computing power, RAM, etc.) for checking and processing the ticket TI′. However, many process installations often only contain older field devices that do not have the required components and resources.

The method according to the present disclosure makes it possible to overcome this disadvantage and to apply the principle for managing the users known from the prior art to old field devices too.

The core of the present disclosure consists in a (software-side) adaptation of the transport medium TM, which mediates between the two worlds (user database DB and old field devices) with regard to authentication. This adaptation is applicable to all types of active transport media (laptops, mobile devices, etc.) and is not dependent upon the type of communications interface KS of a field device FG. In contrast to the prior art, however, passive transport mediums (memory cards, etc.) cannot be used, since the transport medium TM plays an active role in the method.

In a first step 1., old field devices, i.e., field devices that are already in the installation's inventory and which cannot apply the concept described in the prior art, are created as a data record in the user database DB. One or more items of second user data and authorizations are added to each of these field devices FG newly entered in the user database DB. The second user data are field device-specific logins that are used to log in to a field device FG in a manner specific to the user role. For example, these are (short) passwords or PIN's (e.g., containing four digits). An authorization defines which functionalities may be executed on the field device FG after logging in with certain second user data. The second user data and authorizations are already stored in the field devices.

The user database DB also contains a plurality of user accounts, to which user accounts first user data (e.g., login and password) are assigned. The user accounts are linked to the newly created field devices and associated entries (second user data, authorizations) according to the authorization groups assigned to the user accounts.

A ticket TI is then generated, which is transmitted from the user database DB to the transport medium TM via the first communications link KV1, formed via a local network or via the Internet. The ticket is intended to enable a user to operate the field device FG using the transport medium TM. The ticket has a cryptographically secured data region which contains identification information ID, e.g., a serial number, of the field device FG to be operated, the first user information BD1 of the user, and the second user information BD, which have been selected based upon the user's role.

The transport medium TM and the user database have previously established a trust relationship through exchanging cryptographically relevant information (e.g., a public key of a key pair). Using the exchanged cryptographically relevant information from the user database DB, the transport medium TM checks the authenticity and integrity of the ticket TI in a second step 2. If this check confirms the authenticity and integrity of the ticket, the transport medium requires the user to authenticate themselves to the transport medium by entering the first user data (e.g., username and password).

After successful authentication of the user, the transport medium processes the ticket TI. Based upon the identification information of the field device FG, the transport medium TM creates an operating telegram BT specific to the field device FG. An operating telegram is a data packet addressed to the field device FG and the second user data BD2. The operating telegram BT is created in a specific data format that can be understood by the field device FG. For example, the transport medium TM has a list for this purpose that contains all field devices in the installation and the protocols they use for communication. In the present case, the field device has a communications interface KS' based upon the CDI protocol, and therefore the operating telegram is structured according to this protocol.

After establishing a second, CDI-based and wired, communications link KV2 between the transport medium TM and the field device FG, the transport medium TM transmits the operating telegram BT to the field device FG. The field device processes the operating telegram in a method step 3., checks the second user data BD2, and then enables the transport medium TM to access the functionalities defined in the user role. The field device FG can then be operated according to the user's role.

To increase security, the second user data BD2 are changed regularly. This must be done both in the user database DB and in the field device FG itself. To do this, the user changes the second user data BD2 in the user database DB.

The modified second user data are sent in a ticket TI to the transport medium in a similar manner to that described above, which transport medium transmits the modified second user data to the field device FG as an operating telegram BT. The modified second user data are additional data that are included in the ticket in addition to the other data (in addition to the first user data BD1, the second user data BD2, and the identification information ID) and in the operating telegram (in addition to the second user data BD2). Logging in to the field device FG is carried out using the original second user data BD2.

After modifying the second user data BD2 in the field device FG, the transport medium TM confirms the modification by means of a return ticket, which is transmitted from the transport medium TM via the first communications link KV1 to the user database DB and is registered thereby.

1. A method for managing the users of an automation engineering field device, comprising:
establishing a first communications link between a transport medium and a user database, in particular via a local network or via the Internet;
sending a ticket created by the user database from the user database to the transport medium via the first communications link, wherein the ticket comprises first user data and identification information for the field device, wherein the ticket comprises second user data, wherein the first user data are in a format that cannot be processed by the field device, and wherein the second user data are in a format that can be processed by the field device;
authenticating the user to the transport medium based upon the first user data;
creating a field device-specific operating telegram using the transport medium in the event that the user has been successfully authenticated to the transport medium, wherein the operating telegram contains the second user data;
sending the operating telegram from the transport medium to the field device via a second communications link;
verifying the second user data by means of the field device; and
granting access from the transport medium to the field device based upon verified valid second user data.

2. The method according to claim 1, wherein the first user data contains a user name and a password.

3. The method according to claim 1, wherein the second user data contains a password or a PIN.

4. The method according to claim 1, wherein the second communications link is established before or after the step of creating the field device-specific operating telegram.

5. The method according to claim 1, wherein the field device contains a plurality of operable functionalities, wherein the availability of operable functionalities is grouped into different authorization groups.

6. The method according to claim 5, wherein the second user data are designed such that they allow a login to the field device according to the user's authorization group.

7. The method according to claim 1, wherein the field device is registered in advance in the user database, wherein the registration process comprises adding first user data and second user data.

8. The method according to claim 7, wherein, in the event that the second user data for the field device are changed in the user database, a change ticket is created by the user database which contains an operating command for the field device to change the second user data in the field device.

9. The method according to claim 8, wherein the field device modifies the second user data after receiving the operating command and transmits confirmation thereof to the transport medium, wherein the transport medium transmits a confirmation ticket to the user database containing the confirmation.

10. The method according to claim 1, wherein the tickets exchanged between the user database and the transport medium are encrypted or signed.

11. The method according to claim 1, wherein cryptographically relevant information is transmitted from the user database to the transport medium and from the transport medium to the user database each time, wherein the ticket is encrypted or signed on the basis of the exchanged cryptographic information.

12. A system, comprising:
an automation engineering field device;
a transport medium; and
a user database;
wherein the system is designed to:
establish a first communications link between a transport medium and a user database, in particular via a local network or via the Internet;
send a ticket created by the user database from the user database to the transport medium via the first communications link, wherein the ticket comprises first user data and identification information for the field device, wherein the ticket comprises second user data, wherein the first user data are in a format that cannot be processed by the field device, and wherein the second user data are in a format that can be processed by the field device;
authenticate the user to the transport medium based upon the first user data;
create a field device-specific operating telegram using the transport medium in the event that the user has been successfully authenticated to the transport medium, wherein the operating telegram contains the second user data;
send the operating telegram from the transport medium to the field device via a second communications link;
verify the second user data by means of the field device; and
grant access from the transport medium to the field device based upon verified valid second user data.

13. The system according to claim 12, wherein the transport medium is a computer unit or a mobile device, in particular a smartphone or tablet.

14. The system according to claim 12, wherein the second communications link between the transport medium and the field device is established via a wired connection.

15. The system according to claim 12, wherein the user database is a cloud-based database.
